(19) United States
(12) Patent Application Publication
(10) Pub. No.: US 2009/0301596 A1
(43) Pub. Date: Dec. 10, 2009

(54) INSULATION FOR PIPE-IN-PIPE SYSTEMS

(75) Inventor: Jeroen van Oosten, Walton on Thames (GB)

Correspondence Address: HOFFMANN & BARON, LLP, 6900 JERICHO TURNPIKE, SYOSSET, NY, 11791, US

(73) Assignee: HEEREMA MARINE CONTRACTORS NEDERLAND B.V., Leiden (NL)

(21) Appl. No.: 12/330,632

(22) Filed: Dec. 9, 2008

Related U.S. Application Data
(60) Provisional application No. 61/012,639, filed on Dec. 10, 2007.

(51) Int. Cl. F16L 59/00

(52) U.S. Cl. 138/149; 138/112; 138/148

(57) ABSTRACT

A method of providing an insulated pipe-in-pipe assembly includes providing an inner pipe; providing a thermal insulation layer of a highly porous solid formed from a gel, the highly porous solid having pores smaller than 100 nanometre, the thermal insulation layer being provided around the inner pipe for thermal insulation of the inner pipe; providing a protective layer on the outer surface of the thermal insulation layer for protecting the thermal insulation layer, and providing a thick walled outer pipe around the protective layer. A Pipe-in-pipe assembly and a pipe-in-pipe section made by the method are also provided.

### CROSS-REFERENCE TO RELATED APPLICATIONS

This application claims the benefit of U.S. Provisional Application No. 61/012,639, filed Dec. 10, 2007, the contents of which is incorporated by reference herein.

### FIELD OF THE INVENTION

The field of the invention relates to pipelines, more specifically to insulation of subsea pipelines, more specifically insulation of subsea pipe-in-pipe systems.

### PRIOR ART

Pipe-in-pipe systems (PiP systems) are known in the oil and gas industry. In subsea environments, PiP systems can be used to provide pipelines with good thermal insulation. The insulation material is generally provided in the annulus between the inner and outer pipe to improve the thermal performance of the PiP system. Since the outer pipe will resist the water pressure, no pressure is exerted on the insulation material and consequently, conventional insulation materials can be used.

In particular in deep to ultra deep water, PiP systems are frequently used. PiP systems have a good thermal performance when compared to single wall pipelines. Less heat leaks through the pipe wall to the surrounding environment compared to single wall pipelines.

In some conditions, single wall pipelines with insulation around the pipe (also known as ‘wet coated pipelines’) are also used. However, wet coated pipelines are often less attractive in deep water since there are only a few materials that can resist water pressure at depths over 1,000 meters. These materials are generally very costly.

U.S. Pat. No. 6,179,523 B1 discloses an example of a PiP system with an inner pipe which can slide through the outer pipe. FIGS. 2, 5 and 8 of U.S. Pat. No. 6,179,523 B1 show a PiP system with an inner pipe 34, insulation 60, and an outer pipe 32. The insulation is disclosed to be polyisocyanurate (PIR), see column 5, line 52. PIR is related to PUR and is a low density foam with limited thermal insulation qualities. U.S. Pat. No. 6,179,523 B1 further discloses the use of centralizers 32 at regular intervals and an air gap between the outer diameter of the centralizer and the inner wall of the outer pipe, see column 5, lines 24-30. U.S. Pat. No. 6,179,523 B1 is a system with a relatively wide outer pipe and thus a relatively heavy and expensive PiP system. This system is unsuitable for the present needs in the field of marine pipeline laying.

WO 2006/020615 discloses a method and system for a ‘wet coated pipeline’, i.e. an insulated pipeline without an outer pipeline. WO 2006/020615 discloses a method for extruding a film around a pipe, pouring polyurethane foam within the space defined by the pipeline and the film and subsequently moulding the foam into the required form, followed by curing of the foam. Subsequently, an extra layer of PE may be extruded around the film, see page 10, paragraph 39 of WO 2006/020615. As mentioned, wet coated pipelines are disadvantageous in many situations, in particular in deep water. This system is therefore also unsuitable for the present needs in the field of marine pipeline laying.

As water depths increase, so does the weight of pipelines on a pipelay vessel during installation on the sea bed. Pipe-in-pipe systems are especially heavy since the weight of two pipes needs to be supported by a single installation vessel, e.g. a J-lay vessel or an S-lay vessel. Therefore, there is a general need in the field of the art for light PiP systems.

Since the size of the inner pipe generally is chosen in order allow a certain discharge of fluids through the pipe, the diameter of the inner pipe can generally not be decreased. The main option to make the PiP system lighter is to reduce the size of the outer pipe, in particular the diameter of the outer pipe. This requires the annulus between the inner and outer pipe to be as small as possible. This means that an insulation material should preferably be used which can reach a high thermal insulation by using only a thin layer.

One such a material is Aerogel. Aerogel is a high-quality insulation material having a low thermal conductivity, which is generally expressed in W/m K. Aerogel is known for its excellent insulation capacities, and therefore only a thin layer of material is needed to provide the required thermal insulation.

U.S. Pat. No. 7,226,243 teaches a method of providing a pipe-in-pipe system with aerogel, by helically spooling a thin-walled outer pipe around an inner pipe covered with aerogel. This method is unsuitable for marine pipe-laying, because the thin walled outer pipe is not strong enough to be used in pipelay such as J-lay. Large forces need to be transferred from the vessel to the pipeline, and to this end, the outer pipeline needs to be strong and have substantially wall thickness. The solution of helically winding a thin outer pipe thus is unsuitable for the present needs in the field of marine pipeline laying.

OTC 16505 describes the use of aerogel for PiP systems. During manufacture, the inner pipe is fitted with an aerogel layer and the inner pipe with the aerogel layer is subsequently slid into the outer pipe.

The article ‘New tools and technology for the offshore industry’ in Offshore Online of January 2006 by Ted Moon also describes a PiP system with aerogel.

### THE INVENTION

In the present invention, it was discovered that a sliding pipe-in-pipe system, where the inner pipe can slide within the outer pipe, as proposed in OTC 16505 and the PiP system of ‘New tools and technology for the offshore industry’ creates a high risk of damage to the aerogel layer. It was discovered that for this reason the system as proposed in OTC 16505 and the PiP system of ‘New tools and technology for the offshore industry’ are unsuitable for the field of marine pipeline laying.

Centralizers as proposed in U.S. Pat. No. 6,179,523 would reduce the risk of damage to the sliding pipe-in-pipe system of OTC 16505 and the PiP system of ‘New tools and technology for the offshore industry’ to acceptable levels, but this solution would lead to an increase of the diameter of the outer pipe and thus to an increase in the weight and cost of the overall system. Thus, it was found that combination this is not a suitable way forward.

### OBJECT OF THE INVENTION

It is an object of the present invention to provide a sliding PiP system which provides a good alternative to the prior art.

It is a further object to provide a PiP system which overcomes at least one of the drawbacks of the prior art.

It is another object of the invention to provide a PiP system which allows a smaller air gap between the thermal insulation layer and the outer pipe than necessary for known PiP systems with aerogel.

### SUMMARY OF THE INVENTION

At least one of the objects is achieved by a method of providing an insulated pipe-in-pipe assembly, the method comprising:

providing an inner pipe;

providing a thermal insulation layer of a highly porous solid formed from a gel, the highly porous solid having pores smaller than 100 nanometer, the thermal insulation layer being provided around the inner pipe for thermal insulation of the inner pipe;

providing a protective layer on the outer surface of the aerogel layer for protecting the thermal insulation layer against damage,

providing a thick walled outer pipe around the layer of protective material by moving the combination of an inner pipe, thermal insulation and protective layer into the thick walled outer pipe.

The present invention provides the advantage that the PiP system can be manufactured much easier, since the aerogel layer is protected against damage from the sliding action and thus will not be damaged. The inner pipe with the insulation can be slide into the thick walled outer pipe much easier.

Alternatively or additionally, the air gap between the aerogel layer and the outer pipe may be chosen substantially smaller, since the risk of damage of the aerogel layer is smaller. A primary benefit of the invention is thus a smaller outer pipe and hence a lighter PiP system.

The aerogel layer may comprise one or more blankets of aerogel. The blankets are provided with a protective layer on one side, for instance made of polyethylene (PE). The blankets are still flexible enough to be wrapped around the inner pipe.

Aerogel has an impressive load bearing ability due to the dendrite microstructure, in which spherical particles of average size 2-5 nm are fused together into clusters. These clusters form a three-dimensional highly porous structure of almost fractal chains, with pores smaller than 100 nm.

Silica aerogel is the most common type of aerogel and the most extensively studied and used. It is a silica-based substance, derived from silica gel. The world's lowest-density solid is a silica nanofoam at 1 mg/cm³, which is the evacuated version of the record-aerogel of 1.9 mg/cm³. The density of air is 1.2 mg/cm³. Aerogel has extremely low thermal conductivity (0.03 W/m·K down to 0.004 W/m·K), which gives it remarkable insulating properties.

Other materials may be used which are substantially equivalent to aerogel.

Polyethylene was found to be an effective material for protecting the insulation material during sliding of the inner pipe into the thick walled outer pipe. Other materials are also possible, for instance polypropylene but other materials may be considered as well.

The words “thick walled” indicate a thickness which enables J-lay or S-lay, i.e. which allows the pipeline to be suspended from a pipeline laying vessel by the outer pipe, possibly via collars or other supports mounted onto the outer pipe or integral with the outer pipe.

The present invention relates to providing the insulation material in blankets. On one side of the blanket the flexible yet strong protective layer is provided. The blankets are wrapped around the inner pipe with the PE layer on the outside. The longitudinal seam of the PE layer is closed. Various methods are available for doing this, for instance a melting strip that is closed with the use of propane torches. Also means for emitting UV light may be used.

In the in place situation one side of the aerogel will continuously be loaded by the weight of the inner pipe resting on it. To assure equal insulation properties and to prevent excessive compression of the aerogel blankets due to this long term loading additional supports (centralizers) may be provided. These centralizers may be provided between the inner pipe and the protective layer on the outside of the aerogel blankets, so that the sliding PiP principle is not affected.

In order to improve protection of the insulation material, additional heat shielding means may be applied in on the outside of the insulation material to shield it from the welding heat at the location of the field joints of the outer pipe.

In an embodiment, the thermal insulation layer is made from a silica gel. In an embodiment, the thermal insulation layer is an aerogel layer. A silica gel, in particular an aerogel layer, has been found to provide good thermal insulation.

In an embodiment, the protective layer comprises a layer of Polyethylene. Polyethylene protects the aerogel sufficiently and is relatively easy to apply as a coating on the aerogel layer.

In an embodiment, an annulus of free space is provided between the protective layer and the thick walled outer pipe. The annulus improves the ease with which the inner pipe plus insulation layer plus coating can slide into the thick walled outer pipe, but necessitates a wider outer pipe. Alternatively, no free space is provided between the protective layer and the outer pipe. The assembly becomes more difficult but with the advantage that the outer pipe has a smaller diameter and thus is lighter.

In one aspect of the invention, the protective layer provides a mechanical protection of the thermal insulation layer from outside forces which would otherwise be exerted directly on the thermal insulation layer. The mechanical forces are advantageously prevented from damaging the thermal insulation layer, in particular from outside forces due to the sliding of the inner pipe into the thick walled outer pipe. The protective layer is configured to slide relatively smoothly along the inner wall of the thick walled outer pipe.

In one aspect, support members are provided at substantially regular intervals between the inner pipe and the outer pipe, the support members being configured for carrying lateral loads from the inner pipe to the outer pipe. The support members contact the inner surface of the outer pipe and keep the thermal insulation layer of insulation material which is located in the intervals between the support members substantially free of lateral loads. The inner pipe may be heavy, in particular in use, and may compress the insulation layer, which may be detrimental to the thermal insulation properties of the insulation layer. The support members substantially prevent detrimental effects on the insulation layer.

In one embodiment, the protective layer is provided on the thermal insulation layer prior to the provision of the thermal insulation layer around the inner pipe. In this stage, the insulation layer may be processed relatively easy. A firm connection between the protective layer and the insulation material can be made in a well controlled environment.

In a particular embodiment, the method comprises attaching a layer of Polyethylene to one side of the thermal insulation layer, followed by the provision of the combined aerogel and PE-layer around the inner pipe. This had been found to be an effective way of manufacturing the insulation layer.

Alternatively, the protective layer is provided on the thermal insulation layer after the thermal insulation layer is provided around the inner pipe. Surprisingly, in some conditions it has been found that this sequence provides a fast and effective manufacturing process.

In one embodiment, multiple layers of aerogel are provided around the inner pipe, and only the outer layer of aerogel is covered with a protective layer. Multiple layers provide the possibility of a staggered covering of layers, thereby avoiding seams through which heat can leak. Alternatively, layers of aerogel may be coiled around the inner pipe

A simple way of manufacturing is provided by providing the thermal insulation layer and the protective layer around the inner pipe, wherein subsequently the combination of inner pipe, aerogel and protective layer is moved into the thick walled outer pipe.

A blanket of aerogel may be simply wrapped around the inner pipeline such that the end ridges of the blanket substantially meet one another, thereby defining a seam which extends along the length of the pipeline, and wherein said seam is closed.

In one embodiment the support members are provided prior to the provision of the protective layer. This facilitates a good engagement of the support members with the inner pipe.

In one embodiment, the protective layer is provided such that both the thermal insulation layer and the support members are covered by the protective layer. This allows a good sliding layer to be provided around the support members, leading to good sliding characteristics and easy manufacturing.

The invention also relates to a pipe-in-pipe system comprising:

an inner pipe;

a thick walled outer pipe positioned around the inner pipe, defining an annulus between the inner pipe and the thick walled outer pipe;

a thermal insulation layer of a highly porous solid formed from a gel, the highly porous solid having pores smaller than 100 nanometre, the thermal insulation layer being provided around the inner pipe for thermal insulation of the inner pipe;

a protective layer provided on the outer surface of the thermal insulation layer for protecting the thermal insulation layer.

As discussed above, the present invention enables a lighter pipe-in-pipe assembly and easier construction.

In one embodiment, the outer diameter of the support members is substantially the same as the outer diameter of the insulation material. This allows the annulus between the thick walled outer pipe and the inner pipe with insulation and support members to be reduced to zero and/or to keep the insulation material free of any lateral loads.

In one embodiment the thermal insulation layer extends over a certain length along the pipeline, such that at each end of the thermal insulation layer a support member is provided, so that the support members are flanked on both sides by an thermal insulation layer, and the lengths of thermal insulation layer is flanked at both ends by a support member. A simple compact assembly is thus provided allowing both simple assembly and substantially no deformation of the insulation layer.

The invention also relates to a pipe-in-pipe section comprising:

a single inner pipe section;

a single thick walled outer pipe section positioned around the inner pipe section, defining an annulus between the inner pipe section and the thick walled outer pipe section;

a thermal insulation layer of a highly porous solid formed from a gel, the highly porous solid having pores smaller than 100 nanometre, the thermal insulation layer being provided around the inner pipe for thermal insulation of the inner pipe;

a protective layer provided on the outer surface of the thermal insulation layer for protecting the thermal insulation layer,

wherein the pipe-in-pipe section has opposite ends that are configured to be joined to an end of a second pipe-in-pipe section in order to form a pipe-in-pipe system.

Pre-assembled pipe sections according to the present invention may be assembled into a Pipe-in-pipe pipeline very quickly, leading to a substantial cost advantage.

### BRIEF DESCRIPTION OF THE DRAWINGS

FIG. 1A shows a cross-sectional view of a pipe-in-pipe assembly of the prior art;

FIG. 1B shows a longitudinal sectional view of a pipe-in-pipe assembly of the prior art;

FIG. 2A shows a longitudinal sectional view of a first embodiment of a pipe-in-pipe assembly according to the invention;

FIG. 2B shows a cross-sectional view of a pipe-in pipe assembly of the first embodiment along the line B-B in FIG. 2A;

FIG. 3A shows a longitudinal sectional view of a second embodiment of a pipe-in-pipe assembly according to the invention;

FIG. 3B shows a cross-sectional view of a pipe-in pipe assembly of the second embodiment along the line A-A in FIG. 3A;

FIG. 4A shows a cross-sectional view of a pipe-in pipe assembly of another embodiment according to the invention; and

FIGS. 5a and 5B show detailed longitudinal sectional views of the relative position of the support members and the protective layer.

### DETAILED DESCRIPTION OF THE EMBODIMENTS

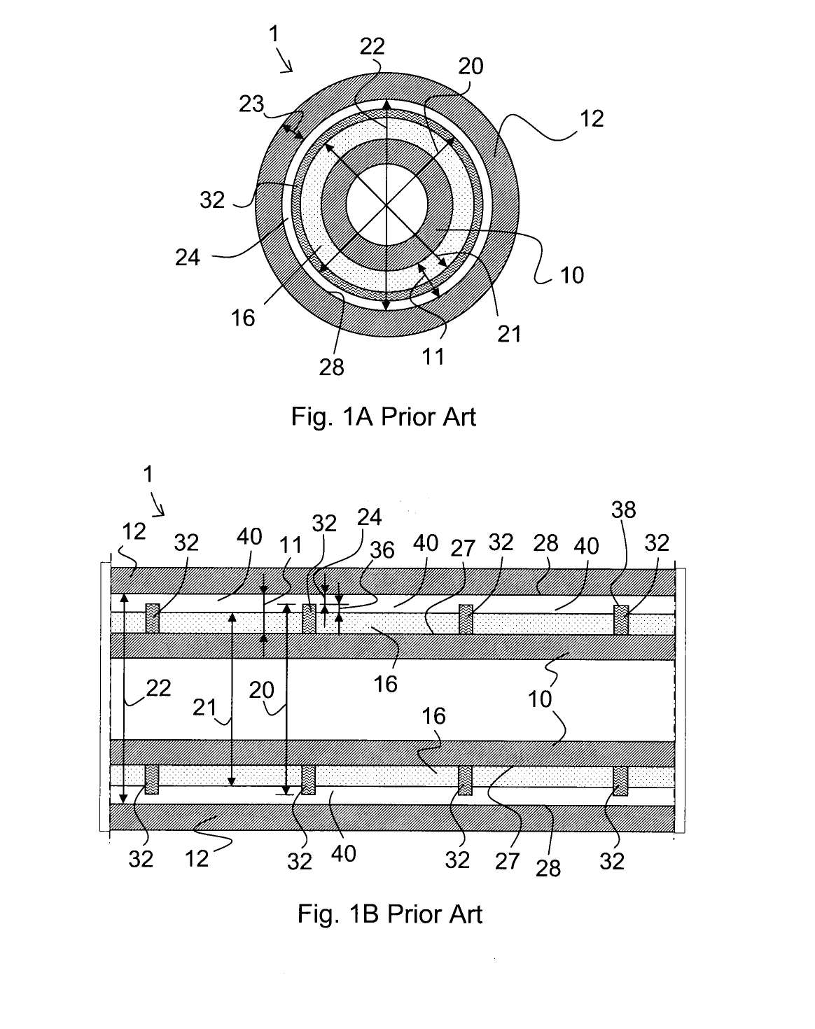

FIGS. 1A and 1B show a pipe-in-pipe assembly 1 of the prior art, i.e. according to U.S. Pat. No. 6,179,523 B1. An inner pipe 10 is provided having an inner diameter and outer diameter and a wall thickness. A thick walled outer pipe 12 is provided around the inner pipe 10. The outer pipe 12 has an inner diameter 22 and an outer diameter and a wall thickness 23. An insulation layer 16 is provided around the inner pipe 10 for thermal insulation. An annulus 11 is defined as the area between the outer wall 27 of the inner pipe and the inner wall 28 of the outer pipe 12.

Centralizers 32 are provided at regular intervals. The centralizers 32 have an outer diameter 20 which is greater than the outer diameter 21 of the insulation layer 16. The centralizers 32 thus project outwardly from the insulation layer 16 over a distance 36, thereby preventing the insulation layer 16 from coming into contact with the inner wall 28 of the outer pipe 12.

Due to the larger diameter 20 of the centralizers 32, annular cavities 40 exists which are defined by the insulation layer 16, the inner wall 28 of the outer pipe 12 and the centralizers 32. U.S. Pat. No. 6,179,523 B1 discloses that these cavities 40 must be in fluid communication with one another in order to allow an insulating gas to be injected into the cavities 40, see column 5 lines 25-35 of U.S. Pat. No. 6,179,523 B1. To this end, an air gap 24 is provided between the outer wall 38 of the centralizer 32 and the inner wall 28 of the outer pipe 12.

The required distance 36 and the required air gap 24 increase the required inner diameter 22 of the outer pipe and together are a cause of a large weight of the outer pipe 12. The cost of the PiP system of U.S. Pat. No. 6,179,523 thus is relatively high.

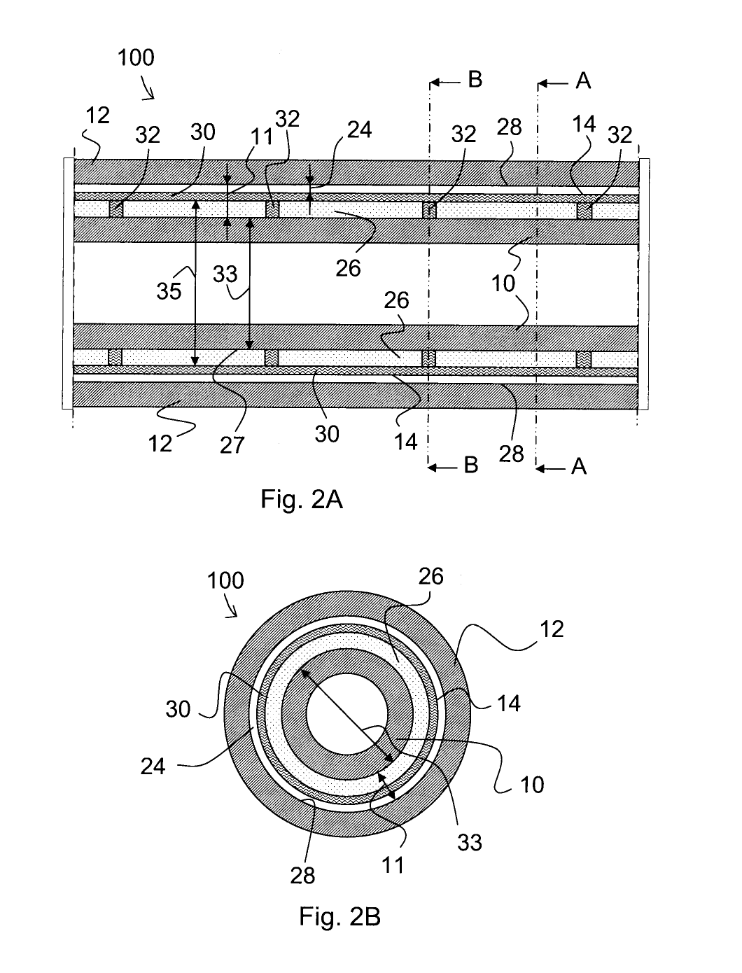

FIGS. 2A and 2B show a pipe-in pipe assembly 100 according to the invention. An inner pipe 10 is provided. An outer pipe 12 envelops the inner pipe 10. An annulus 11 is defined between the inner pipe and the outer pipe 12.

An aerogel layer 26 is provided around the inner pipe 10 for thermal insulation of the inner pipe. A protective layer 30 of Polyethylene (PE) is provided around the aerogel layer 26 for protection of the aerogel layer against damage. The PE layer particularly protects the aerogel layer 26 against damage when the inner pipe and the insulation layer are slid into the outer pipe 12.

Support members 32 may be provided for supporting the inner pipe 10 on the inner wall of the outer pipe 12. The support members 32 are positioned in the annulus 11 between the inner pipe 10 and the outer pipe 12. The support members 32 may be covered by the protective layer 26, but may also not be covered by the protective layer 26 and engage the inner wall 28 of the outer pipe 12 directly.

The support members 32 have a same inner diameter 33 as the aerogel layer 26 and a same outer diameter 35 as the aerogel layer 26. The support members 32 are much stronger and stiffer than the aerogel layer 26, such that in use the lateral forces of the inner pipe 10 are diverted to the outer pipe 12 via the support members 32. Thus, the aerogel layer 26 is kept substantially free of lateral forces which otherwise could compress and/or damage the aerogel layer.

An air gap 24 is provided between the outer wall 14 of the protective layer 30 and the inner wall 28 of the outer pipe. The air gap 24 may be chosen with a very small width.

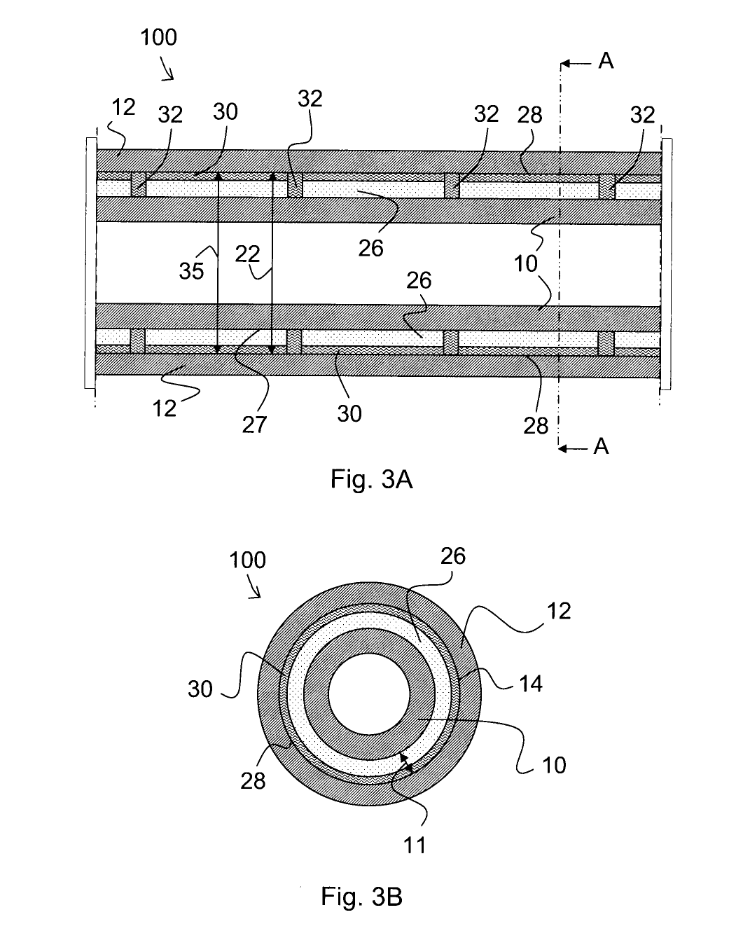

FIGS. 3A and 3b show another embodiment of the PiP assembly 100. The air gap 24 of FIGS. 2A and 2B is not present. The air gap 24 is completely omitted, leading to a smaller diameter of the outer pipe 12 and a lighter PiP system. The outer surface 14 of the protective layer 30 directly engages the inner surface 28 of the outer pipe 12. The outer diameter 35 of the protective layer 30 thus is substantially the same as the inner diameter 22 of the outer pipe 12.

The annulus 11 is thus substantially reduced in comparison with the prior art, leading to a smaller outer pipe 12 and consequently a lighter pipe in pipe assembly.

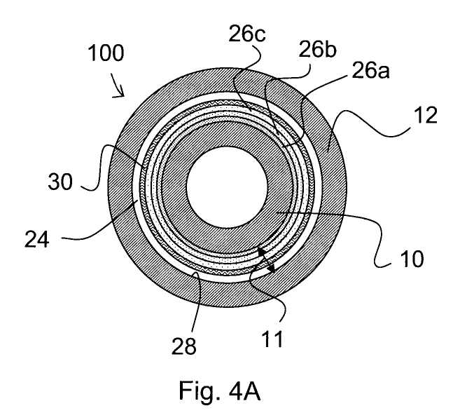

FIG. 4A shows a cross-sectional view of another embodiment, in which a number of aerogel layers 26A, 26B, 26C have been provided. Only the outer layer 26C is provided with a protective layer 30. This embodiment provides a possibility of staggered layers of aerogel, further avoiding leakage of heat through the seams and thus further improving thermal insulation. The aerogel layers 26 may be wrapped or folded around the inner pipe 10.

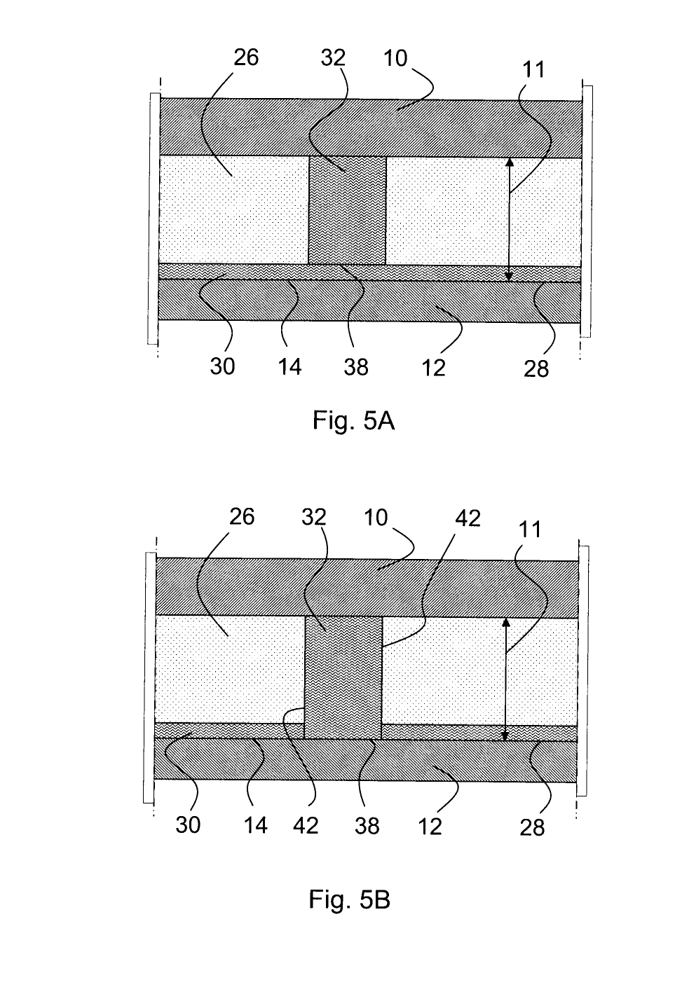

FIG. 5A shows a detailed sectional view of a support member 32 positioned between the inner pipe 10 and the outer pipe 12. The protective layer 30 is shown as covering both the aerogel layer 26 and the support member 32. The protective layer thus covers the inner pipe along the entire length thereof or at least along a large length. This provides very good thermal insulation substantially without any seams through which heat can leak.

FIG. 5B shows an embodiment in which the support members 32 engage the outer pipe 12 directly. The protective layer is interrupted at the location of the support member 32. This embodiment provides good constructional characteristics, since the support members 32 engage both the inner pipe 10 and outer pipe 12. The protective layer meets a side face 42 of the support members 32.

### Manufacturing

In one embodiment, one or more layers 26 of aerogel are wrapped folded, or coiled around the inner pipe 10. At regular intervals, support members 32 are provided in between sections of aerogel. Subsequently, the protective layer 30 is provided around the support members 32 and the aerogel layer 26. Next, the inner pipe 10 with support members 32 and aerogel layer 26 is inserted into the outer pipe 12.

It is possible to provide the support members 32 prior to the protective layer 30. However, it is also possible to provide sections of the protective layer 30 around the inner pipe 10 first and to insert the support members 32 between sections of protective layer 30 afterwards.

It is also possible to first provide an aerogel 26 layer with a protective layer 30, i.e. prior to the provision of the aerogel layer onto the inner pipe. This sequence allows a well controlled application of the protective layer onto the aerogel layer. A sturdy and high quality connection is thus possible between the aerogel layer 26 and the protective layer 30.

1. A method of providing an insulated pipe-in-pipe assembly, the method comprising:
providing an inner pipe;
providing a thermal insulation layer of a highly porous solid formed from a gel, the highly porous solid having pores smaller than 100 nanometre, the thermal insulation layer being provided around the inner pipe for thermal insulation of the inner pipe;
providing a protective layer on the outer surface of the thermal insulation layer for protecting the thermal insulation layer, and
providing a thick walled outer pipe around the protective layer by moving the combination of inner pipe, thermal insulation and protective layer into the outer pipe.

2. The method of claim 1, wherein the thermal insulation layer is made from a silica gel.

3. The method of claim 1, wherein the thermal insulation layer is an aerogel layer.

4. The method of claim 1, wherein the protective layer comprises a layer of Polyethylene.

5. The method of claim 1, wherein an annulus of free space is provided between the protective layer and the thick walled outer pipe.

6. The method of claim 1, wherein the protective layer provides a mechanical protection of the thermal insulation layer from outside forces which would otherwise be exerted directly on the thermal insulation layer.

7. The method of claim 1, wherein the protective layer provides a mechanical protection of the thermal insulation layer from outside forces due to the sliding of the inner pipe into the thick walled outer pipe.

8. The method of claim 1, further comprising:
providing support members at substantially regular intervals between the inner pipe and the thick walled outer pipe, the support members being configured for carrying lateral loads from the inner pipe to the thick walled outer pipe.

9. The method of claim 1, wherein the protective layer is provided on the thermal insulation layer prior to the provision of the thermal insulation layer around the inner pipe.

10. The method of claim 1, comprising attaching a layer of Polyethylene to one side of the thermal insulation layer, followed by the provision of the combined aerogel and PE-layer around the inner pipe.

11. The method of claim 1, wherein the protective layer is provided on the thermal insulation layer after the thermal insulation layer is provided around the inner pipe.

12. The method of claim 1, wherein multiple layers of aerogel are provided around the inner pipe, and wherein only the outer layer of aerogel is covered with a protective layer.

13. The method of claim 1, wherein the thermal insulation layer and the protective layer are provided around the inner pipe, and wherein subsequently the combination of inner pipe, aerogel and protective layer is moved into the thick walled outer pipe.

14. The method of claim 1, wherein a blanket of aerogel is wrapped around the inner pipeline such that the end ridges of the blanket substantially meet one another, thereby defining a seam which extends along the length of the pipeline, and wherein said seam is closed.

15. The method of claim 8, comprising providing the support members prior to the provision of the protective layer.

16. The method of claim 15, comprising providing the protective layer such that both the thermal insulation layer and the support members are covered by the protective layer.

17. A pipe-in-pipe system comprising:
an inner pipe;
a thick walled outer pipe positioned around the inner pipe, defining an annulus between the inner pipe and the thick walled outer pipe;
a thermal insulation layer of a highly porous solid formed from a gel, the highly porous solid having pores smaller than 100 nanometre, the thermal insulation layer being provided around the inner pipe for thermal insulation of the inner pipe; and
a protective layer provided on the outer surface of the thermal insulation layer for protecting the thermal insulation layer.

18. The pipe-in-pipe system of claim 17, wherein the thermal insulation layer is made from a silica gel.

19. The pipe-in-pipe system of claim 17, wherein the thermal insulation layer is an aerogel layer.

20. The pipe-in-pipe system of claim 17, wherein the protective material is Polyethylene.

21. The pipe-in-pipe system of claim 17, further comprising support members positioned between the inner pipe and the thick walled outer pipe, the support members being configured for supporting the inner pipe, the support members being positioned at intervals from one another as viewed in the axial direction of the pipe-in-pipe system.

22. The pipe-in-pipe system of claim 17, wherein the support members contact the inner surface of the thick walled outer pipe and keep the thermal insulation layer of insulation material which is located in the intervals between the support members substantially free of lateral loads.

23. The pipe-in-pipe system of claim 21, wherein the outer diameter of the support members is substantially the same as the outer diameter of the insulation material.

24. The pipe-in-pipe system of claim 21, wherein the outer diameter of the support members is greater than the outer diameter of the insulation material.

25. The pipe-in-pipe system of claim 21, wherein the protective layer covers both the thermal insulation layer and the support members such that the support members are provided within the protective layer.

26. The pipe-in-pipe system of claim 17, wherein the thermal insulation layer extends over a certain length along the pipeline, and wherein at each end of the thermal insulation layer a support member is provided, such that the support members are flanked on both sides by an thermal insulation layer, and the lengths of thermal insulation layer is flanked at both ends by a support member.

27. The pipe-in-pipe assembly of claim 17, wherein the outer diameter of the protective layer is smaller than the diameter of the inner wall of the thick walled outer pipe, thereby defining a gap between the protective layer and the thick walled outer pipe.

28. A pipe-in-pipe section comprising:
a single inner pipe section;
a single thick walled outer pipe section positioned around the inner pipe section, defining an annulus between the inner pipe section and the thick walled outer pipe section;
a thermal insulation layer of a highly porous solid formed from a gel, the highly porous solid having pores smaller than 100 nanometre, the thermal insulation layer being provided around the inner pipe for thermal insulation of the inner pipe; and
a protective layer provided on the outer surface of the thermal insulation layer for protecting the thermal insulation layer,
wherein the pipe-in-pipe section has opposite ends that are configured to be joined to an end of a second pipe-in-pipe section in order to form a pipe-in-pipe system according to claim 17.
